(19) United States
(12) Patent Application Publication
(10) Pub. No.: US 2012/0081736 A1
(43) Pub. Date: Apr. 5, 2012

(54) PRINT MARK ON PAPER EDGE FOR EASIER SORTING

(75) Inventors: Shaun PINNEY, Fremont, CA (US); Hao HU, Belmont, CA (US)

(73) Assignee: Konica Minolta Systems Laboratory, Inc., Huntington Beach, CA (US)

(21) Appl. No.: 12/894,561

(22) Filed: Sep. 30, 2010

(51) Int. Cl. G06F 3/12

(52) U.S. Cl. 358/1.15

(57) ABSTRACT

A method executed by an image forming apparatus for producing a print job, which includes the steps of: (a) receiving data representing a document to be printed in the print job; (b) receiving job information about the print job, the job information including an instruction to print multiple copies of the document; (c) printing the requested multiple copies of the document; and (d) printing a mark on an edge of at least one sheet of each of the multiple copies of the document.

### FIELD OF THE INVENTION

This invention relates to an image forming apparatus and, more particularly to a system and method of printing a mark on an edge of at least one of the sheets of the print job to identify the at least one sheet as a separation sheet for sorting of the multiple copies of the document.

### BACKGROUND OF THE INVENTION

Collation of multiple copies of a printed document is typically accomplished with multi function peripheral (MFP) devices by either using multiple trays and/or by shifting each collated set of the document. However, it can be appreciated that smaller image forming apparatuses including the all-in-one (AIO) may not have the capacity and/or functional ability to perform shifting of each collated set of documents.

Accordingly, it would be desirable to have a method and system wherein multiple copies of a document can be separated from one another without the use of multiple trays, inserts, and/or shifting of each collated print copy.

### OBJECTS AND SUMMARY

The present invention has been made in consideration of the above issues, and provides an improved image forming apparatus and method by printing a mark on an edge of at least one of the sheets of the print job to identify the at least one sheet as a separation sheet for sorting of the multiple copies of the document.

In accordance with an exemplary embodiment, a method executed by an image forming apparatus for producing a print job, comprises: (a) receiving data representing a document to be printed in the print job; (b) receiving job information about the print job, the job information including an instruction to print multiple copies of the document; (c) printing the requested multiple copies of the document; and (d) printing a mark on an edge of at least one sheet of each of the multiple copies of the document.

In accordance with another exemplary embodiment, a computer program product comprising a computer usable medium having a computer readable code embodied therein for controlling an image forming apparatus, the computer readable program code configured to cause the image forming apparatus to execute a process for producing a print job, the process comprising the steps of: (a) receiving data representing a document to be printed in the print job; (b) receiving job information about the print job, the job information including an instruction to print multiple copies of the document; (c) printing the requested multiple copies of the document; and (d) printing a mark on an edge of at least one sheet of each of the multiple copies of the document.

In accordance with a further exemplary embodiment, an image forming apparatus comprises: an image forming apparatus comprising: a memory unit, the memory unit having a firmware application, which performs the following: (a) receiving data representing a document to be printed in the print job; (b) receiving job information about the print job, the job information including an instruction to print multiple copies of the document; (c) printing the requested multiple copies of the document; and (d) printing a mark on an edge of at least one sheet of each of the multiple copies of the document; and a print engine connected to the memory unit for forming an image on a recording medium.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a data processing system, which includes a host computer and an image forming apparatus or printer connected to the host computer in accordance with an exemplary embodiment.

FIG. 2 is a diagram showing the configuration of an image forming apparatus in accordance with an exemplary embodiment of the present invention.

FIG. 3 is a perspective view of a mark on an edge of at least one sheet of each of the multiple copies of the document, and which functions as a separation page in accordance with an exemplary embodiment of the present invention.

FIGS. 4A-4E are illustration of sheets having a mark printed on a right edge, top edge, a bottom edge, a left edge, and extending down an entire edge of one sheet of multiple copies of the document, respectively.

FIG. 5 is a flow chart of a method executed by an image forming apparatus for producing a print job in accordance with an exemplary embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

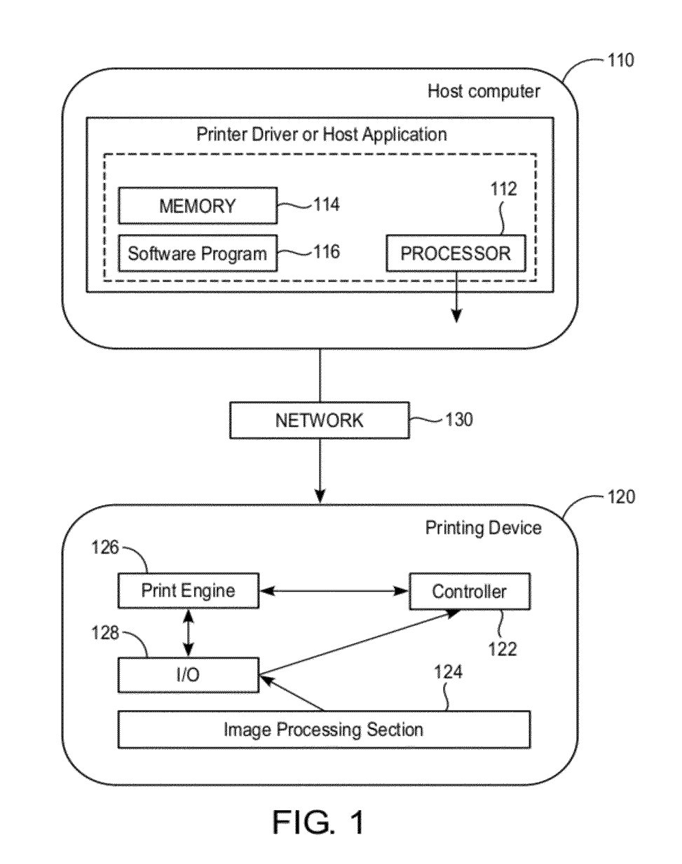

The methods described herein can be implemented in a data processing system 100, which includes a host computer 110, and an image forming apparatus in the form of a printer 120 connected to the host computer 110. A typical structure of the data processing system is shown in FIG. 1. The host computer 110 includes a processor 112 and one or more memories 114 for storing software programs 116 and data (such as files to be printed). The host computer 110 submits print jobs to the image forming apparatus (or printer) 120 by transmitting data representing the documents to be printed and information describing the print job. The image forming apparatus (or printer) 120 includes a controller 122, an image processing section 124, a print engine 126, and an input/output (I/O) section 128.

The controller 122 may include a central processing unit (CPU), a random access memory (RAM), and a read only memory (ROM). The controller 122 processes the data and job information received from the host computer 110 to generate a print image. The image processing section 124 carries out various image processing under the control of the controller 122, and sends the processed print image data to the print engine 126. The print engine 126 forms an image on a recording sheet based on the image data sent from the image processing section 124. The I/O section performs data transfer with the host computer 110. The controller 122 is programmed to process data and control various other components of the image forming apparatus or printer 110 to carry out the various methods described herein.

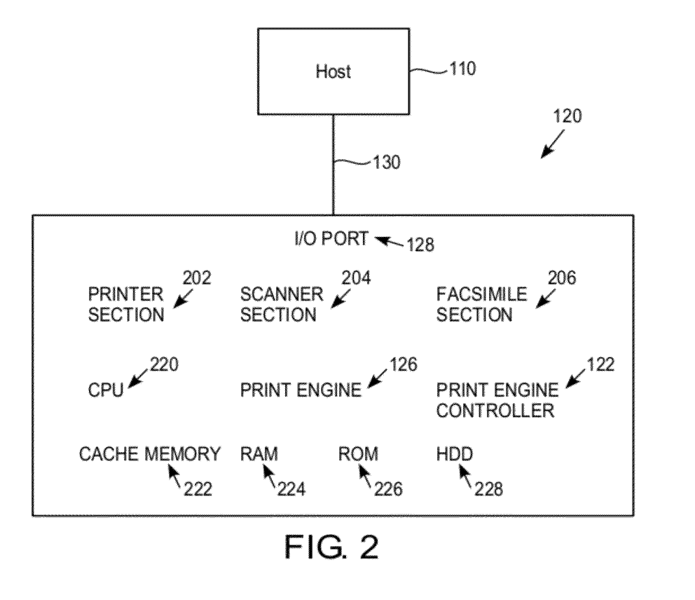

FIG. 2 is a diagram showing the configuration of an image forming apparatus 120 in accordance with an exemplary embodiment of the present invention. In accordance with an exemplary embodiment, the image forming apparatus 120 is configured as a multi function peripheral (MFP) device or all-in-one (AIO) that includes a printer section 202 for converting print data inputted from outside to image data and forming and printing out the converted image onto a sheet, a scanner section 204 for optically reading a document, and a facsimile section 206 for facsimile receiving and transmitting image data to and from external apparatuses through public lines.

In accordance with an exemplary embodiment, the printer section 202 carries out a function for forming and outputting an image corresponding to the image data onto the recording sheet using an electro-photographic process. In accordance with an exemplary embodiment, the printer section 202 is configured as a so-called laser printer having a recording sheet conveying device (not shown in the drawing), a photoreceptor drum, a charging unit, an LD (Laser Diode) being modulated lighting corresponding to the image data inputted, a scanning unit for scanning the laser light irradiated from the LD on the photoreceptor drum, a developing unit, a transfer and separation unit, a cleaning unit, and a fixing unit.

The scanner section 204, which includes the copying section carries out a function to read a document and obtain the image data and comprises a light source, a CCD (Charge Coupled Device) image sensor for reading the document by one line at a time in a width direction, and an A/D converter for converting an analogue image signal outputted by the image sensor to digital image data. Although not shown in the drawing, the scanner section 204 further comprises a moving mechanism for moving the reading position per one line of the image sensor in a longitudinal direction of the document and optical parts comprising a lens and a mirror for guiding the reflected light from the document and focusing image on the image sensor.

The facsimile section 206 connects to a public line (not shown) and has a function to compress and expand the image data with the compression mode complying with facsimile, and a function to control various communication protocols for sending and receiving facsimile through the public line.

In accordance with an exemplary embodiment, the image forming apparatus 120 includes a print engine 126, which is controlled by a microprocessor (or CPU) 220. The microprocessor 220 communicates with other elements of the apparatus and includes a cache memory 222. A print engine controller (or printer controller) 122 and the associated print engine 126 provides the print output capability for the printer section 202. A random access memory (RAM) 224 provides a main memory for the printing section 202 for storing and processing a print job data stream received from the client device or host computer 240. A read only memory (ROM) 226 and Hard Disk Drive (HDD) 228 holds firmware which controls the operation of microprocessor (or CPU) 220 and print engine 126. Here, the firmware includes software applications for executing basic controls of various hardware of the image forming apparatus 120, and an embedded Operating System (OS), which controls the operation of the image forming apparatus 120. Code procedures stored in memory (ROM) 226 include, for example, a page converter, rasterizer, compression code, page print scheduler and print engine manager.

An input/output (I/O) port 128 provides communications between the printer section 202 and a client device (or host) 110 and receives page descriptions (or print data) from the host for processing within the image forming apparatus 120. In accordance with an exemplary embodiment, the operation of printer section 202 commences when it receives a page description from client device (or host) 110 via I/O port 128 in the form of a print job data stream.

In accordance with an exemplary embodiment as shown in FIG. 2, the image forming apparatus (or printer) 120 and the client device (or host) 110 are connected to each other via a network (e.g., LAN or WAN) 130. In accordance with an exemplary embodiment, the image forming apparatus 120 receives a print job from the client device or host 110, which is then printed onto at least one sheet of paper and/or other printable medium. Examples of the network consistent with embodiments of the invention include, but are not limited to, the Internet, an intranet, a local area network (LAN) and a wide area network (WAN). The image forming apparatus 120 and the client device can be connected with a wire or be connected with wireless by using radio frequency (RF) and/or infrared (IR) transmission. Examples of image forming apparatuses 120 consistent with exemplary embodiments of the invention include, but are not limited to, a laser beam printer (LBP), an LED printer, a multi-functional laser beam printer including copy function (MFP). In accordance with an exemplary embodiment, the image forming apparatus 120 is preferably a color printer or a black and white (B/W) printer.

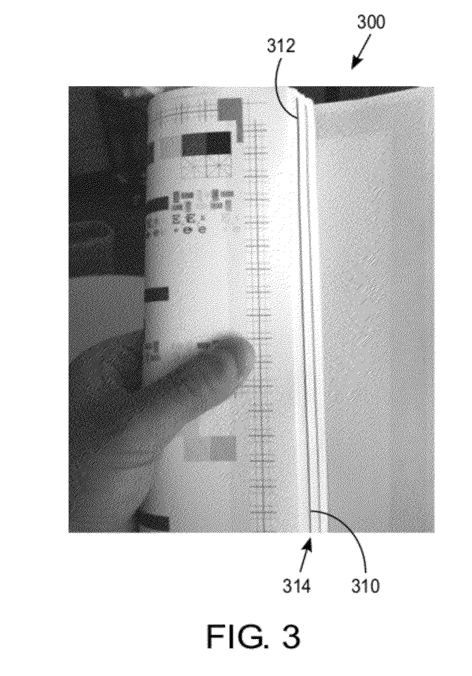

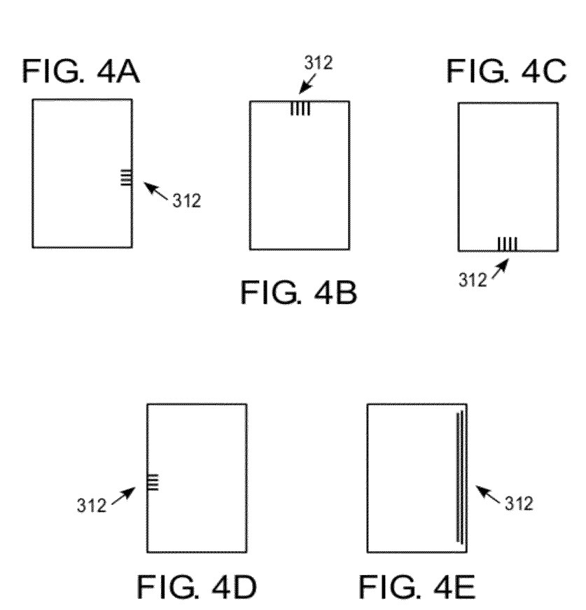

FIG. 3 is a perspective view of a mark on an edge of at least one sheet of each of the multiple copies of the document, and which functions as a separation page. As shown in FIG. 3, the multiple copies 300 of the document are printed with a mark 312 on an edge 314 of at least one sheet 310 of each of the multiple copies of the document. The mark 312 is preferably printed on a right edge of the sheet (FIG. 4A), a top edge of the sheet (FIG. 4B), a bottom edge of the sheet (FIG. 4C), a left edge of the sheet (FIG. 4D), and/or any combination thereof. It can be appreciated that in an alternative embodiment, the mark 312 can extend along an entire edge (i.e., right, left, top, or bottom) of the sheet (FIG. 4E) and the height and width of the mark 312 is adjustable.

In accordance with an exemplary embodiment, the mark 312 is preferably a printed pattern or indicia, which upon gathering and stacking of the multiple copies of the document, the mark 312 is visible upon creasing the stack of multiple copies. The mark 312 can be one or more lines, symbols and/or other markings, which can be used to sort the printed sheets into separate stacks of each copy of the document. The mark 312 is preferably printed on at least one sheet 310 of each of the multiple copies (or sets) of the document. However, in accordance with an alternative embodiment, the mark 312 can be printed on more than one sheet of each set of multiple copies.

In addition, rather than the last sheet of each set of documents, the first sheet of each set of collated documents can be printed with a mark 312 on the edge of the sheet. In accordance with an exemplary embodiment, once the marks 312 are visible, each of the multiple copies (or sets of documents) can be easily separated from one another by use of the mark 312. It can be appreciated that by printing a mark 312 on at least one sheet of each copy of the document, multiple copies of a document can be separated from one another without the use of multiple trays, inserts, and/or shifting of each collated print copy. For example, printing 25 copies of a three (3) sheet print job with a separate insert would use almost a ⅓ more sheets than printing a mark 312 on an edge of at least one sheet 310 of each of the multiple copies of the document as described herein.

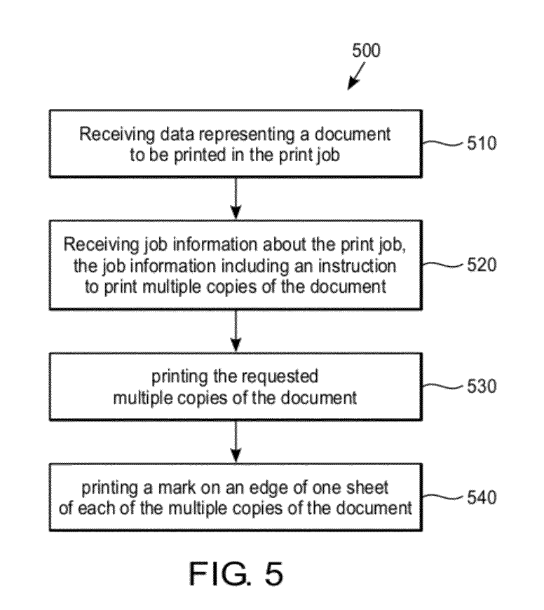

FIG. 5 is a flow chart of a method executed by an image forming apparatus for producing a print job 500, which comprises the steps of: (a) receiving data representing a document to be printed in the print job 510; (b) receiving job information about the print job, the job information including an instruction to print multiple copies of the document 520; (c) printing the requested multiple copies of the document 530; and (d) printing a mark on an edge of at least one sheet of each of the multiple copies of the document 540.

It can be appreciated that the methods as described herein can also be implemented by a computer program product comprising a non-transitory computer usable medium having a computer readable code embodied therein for controlling an image forming apparatus, the computer readable program code configured to cause the image forming apparatus to execute a process for producing a print job as described herein. In accordance with an exemplary embodiment, step (a) includes scanning an original hard copy of the document on the image forming apparatus to generate the data representing the document to be printed, and step (b) includes receiving the job information from an input panel of the image forming apparatus. In accordance with another exemplary embodiment, the job information includes a parameter indicating whether a first or a last sheet of each sheet of each set of the multiple copies of the document is printed with a mark on the edge of the sheet.

It can be appreciated that the process and method can be introduced into the apparatus by updating the firmware in the non-volatile memory of the image forming apparatus. In this regard, the method may be brought to the apparatus in a foam of a package of install software and the firmware, which may be divided and/or compressed so that the install software effectively installs the firmware. The package may be steadily stored in a computer readable diskette, such as a compact disk, or may be transmitted through a wire/wireless communication line.

The method described above can be used to print on paper or other suitable printing medium such as thin plastic sheets, etc. The computer readable medium, of course, can be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention can be implemented such that its software part has been written onto a recording medium in advance and will be read as required in operation.

Thus, as used in this disclosure and the appended claims, the term “image forming apparatus”, “printer” or “printing device” should be broadly understood to refer to any machine that has a print function, including printers, copiers, and all-in-one machines which have printing, scanning and copying functions. The term “print job” and/or “printing” similarly include both printing and copying, i.e., it refers to producing images on a recording medium either from a data received from an external device such as a host computer or from data generated by scanning an original hard copy.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method executed by an image forming apparatus for producing a print job, comprising:
(a) receiving data representing a document to be printed in the print job;
(b) receiving job information about the print job, the job information including an instruction to print multiple copies of the document;
(c) printing the requested multiple copies of the document; and
(d) printing a mark on an edge of at least one sheet of each of the multiple copies of the document.

2. The method of claim 1, wherein the mark is a printed pattern that extends to the edge of the at least one sheet of each of the multiple copies of the document.

3. The method of claim 1, wherein the mark is printed on a right edge of the at least one sheet.

4. The method of claim 1, wherein the mark is printed on a top edge of the at least one sheet.

5. The method of claim 1, wherein the mark is printed on a bottom edge of the at least one sheet.

6. The method of claim 1, wherein the mark is printed on a left edge of the at least one sheet.

7. The method of claim 1, wherein the mark extends along an entire right edge of the at least one sheet.

8. The method of claim 1, wherein the at least one sheet of each of the multiple copies of the document, which includes a mark on the edge of the sheet, is a first sheet of each set of the multiple copies of the document.

9. The method of claim 1, wherein the at least one sheet of each of the multiple copies of the document, which includes a mark on the edge of the sheet, is a last sheet of each set of the multiple copies of the document.

10. The method of claim 1, wherein the job information includes a parameter indicating whether a first or a last sheet of each sheet of each set of the multiple copies of the document is printed with a mark on the edge of the sheet.

11. The method of claim 1, wherein in steps (a) and (b), the data and the job information are received from a host computer connected to the image forming apparatus.

12. The method of claim 1, wherein step (a) includes scanning an original hard copy of the document on the image forming apparatus to generate the data representing the document to be printed, and wherein step (b) includes receiving the job information from an input panel of the image forming apparatus.

13. The method of claim 1, further comprising a firmware application within the image forming apparatus, which controls printing the mark on the edge of the at least one sheet of each of the multiple copies of the document.

14. A computer program product comprising a non-transitory computer usable medium having a computer readable code embodied therein for controlling an image forming apparatus, the computer readable program code configured to cause the image forming apparatus to execute a process for producing a print job, the process comprising the steps of:
(a) receiving data representing a document to be printed in the print job;
(b) receiving job information about the print job, the job information including an instruction to print multiple copies of the document;
(c) printing the requested multiple copies of the document; and
(d) printing a mark on an edge of at least one sheet of each of the multiple copies of the document.

15. The computer program product of claim 14, wherein the job information includes a parameter indicating whether a first or a last sheet of each sheet of each set of the multiple copies of the document is printed with a mark on the edge of the at least one sheet.

16. The computer program product of claim 14, wherein step (a) includes scanning an original hard copy of the document on the image forming apparatus to generate the data representing the document to be printed, and wherein step (b) includes receiving the job information from an input panel of the image forming apparatus.

17. An image forming apparatus comprising:
a memory unit, the memory unit having a firmware application, which performs the following:
(a) receiving data representing a document to be printed in the print job;
(b) receiving job information about the print job, the job information including an instruction to print multiple copies of the document;
(c) printing the requested multiple copies of the document; and
(d) printing a mark on an edge of at least one sheet of each of the multiple copies of the document; and
a print engine connected to the memory unit for forming an image on a recording medium.

18. The image forming apparatus of claim 17, wherein the mark is a printed pattern that extends to the edge of the at least one sheet of each of the multiple copies of the document.

19. The image forming apparatus of claim 17, wherein the mark is printed on a right edge, a top edge, a bottom edge, and/or a left edge of the at least one sheet.

20. The image forming apparatus of claim 17, wherein the mark extends along an entire right edge, top edge, bottom edge, and/or left edge of the at least one sheet.
